(19) United States
(12) Patent Application Publication
(10) Pub. No.: US 2012/0077534 A1
(43) Pub. Date: Mar. 29, 2012

(54) WIRELESS COMMUNICATION METHOD AND WIRELESS DEVICE

(75) Inventors: Ryoko MATSUO, Tokyo (JP); Tomoya TANDAI, Tokyo (JP); Takeshi TOMIZAWA, Tokyo (JP)

(73) Assignee: KABUSHIKI KAISHA TOSHIBA, Tokyo (JP)

(21) Appl. No.: 13/245,445

(22) Filed: Sep. 26, 2011

(30) Foreign Application Priority Data
Sep. 29, 2010 (JP) 2010-219987

(51) Int. Cl. H04W 72/04

(52) U.S. Cl. 455/509

(57) ABSTRACT

According to one embodiment, there is provided a wireless communication method, including: a start step of performing a connection process with a second wireless device; a communication step of performing communication for a predetermined term in a first mode; a determination step of determining, in accordance with a communication status, whether to change a communication mode from the first mode to a second mode in which communication at a higher speed than the first mode is performed, change an operating frequency channel for communication to another frequency channel than the first frequency channel, or continue the first mode; and a transmission step of transmitting a mode change signal when the determination is made to change the communication mode, and transmitting a channel change signal when the determination is made to change the operating frequency channel.

### CROSS-REFERENCE TO RELATED APPLICATION(S)

This application claims priority from Japanese Patent Application No. 2010-219987 filed on Sep. 29, 2010, the entire contents of which are incorporated herein by reference.

### FIELD

Embodiments described herein relate generally to wireless communication.

### BACKGROUND

When there are plural systems which use one and the same frequency band to perform communication, it is important to avoid interference among the systems. To avoid such interference, there is a method in which frequency channels to be used are carrier-sensed one by one for over a predetermined time and an interference-free channel is selected from the frequency channels so that a new network is established on the interference-free channel. For example, in a wireless system where a parent station exists, the parent station typically reports control information (Beacon) in a regular interval (hereinafter referred to as Beacon interval). Since it is necessary to carrier-senses each channel in an interval not shorter than the Beacon interval, a carrier sensing time equal to “time per channel (several times as long as Beacon interval) x the number of channels)” is required.

When each channel is carrier-sensed as described above, it will take a long time for a wireless device belonging to the system to start data transmission after starting a connection process.

### BRIEF DESCRIPTION OF THE DRAWINGS

FIG. 1 illustrates a system configuration according to a first embodiment.

FIG. 2 illustrates an operation flow of a first wireless device 1 according to the first embodiment.

FIG. 3 illustrates an operation flow of the first wireless device 1 according to the first embodiment.

FIG. 4 illustrates an operation flow of the first wireless device 1 according to the first embodiment.

FIG. 5 illustrates an operation flow of a second wireless device 2 according to the first embodiment.

FIG. 6 illustrates an operation flow of the second wireless device 2 according to the first embodiment.

FIG. 7 illustrates an operation flow of the second wireless device 2 according to the first embodiment.

FIG. 8 illustrates a configuration of the first wireless device 1 according to the first embodiment.

FIG. 9 illustrates an operation flow of a first wireless device 1 according to a second embodiment.

FIG. 10 illustrates an operation flow of a second wireless device 2 according to the second embodiment.

FIG. 11 illustrates an operation flow of a first wireless device 1 according to a third embodiment.

FIG. 12 illustrates an operation flow of a second wireless device 2 according to the third embodiment.

FIG. 13 illustrates an application example of the wireless system according to a fourth embodiment.

FIG. 14 illustrates another application example of the wireless system according to the fourth embodiment.

FIG. 15 illustrates a further application example of the wireless system according to a fifth embodiment.

### DETAILED DESCRIPTION

According to one embodiment, there is provided a wireless communication method, including: a start step of performing a connection process with a second wireless device; after the start step, a communication step of performing communication for a predetermined term in a first mode in which a first term and a second term are repeated, the first term for performing communication with the second wireless device on a first frequency channel, the second term for carrier-sensing any other frequency channel than the first frequency channel; a determination step of determining, in accordance with a communication status in the communication step, whether to change a communication mode from the first mode to a second mode in which communication at a higher speed than the first mode is performed, change an operating frequency channel for communication to another frequency channel than the first frequency channel, or continue the first mode; and a transmission step of transmitting a mode change signal when the determination is made to change the communication mode to the second mode, and transmitting a channel change signal when the determination is made to change the operating frequency channel, to the other frequency channel than the first frequency channel.

### First Embodiment

A first embodiment will be described below in detail with reference to the drawings.

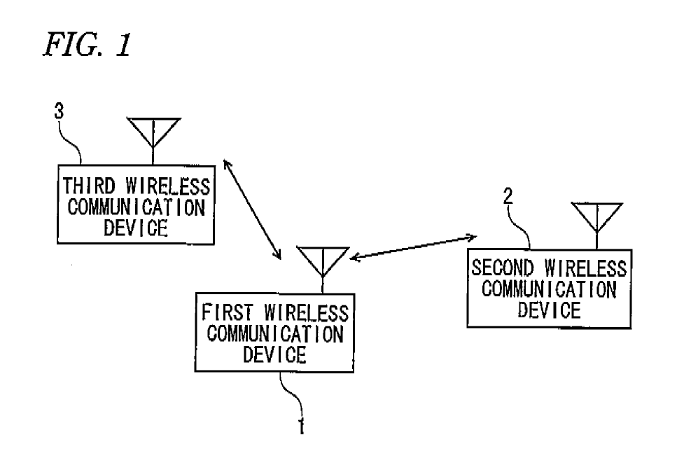

First, a wireless system according to the embodiment will be schematically described with reference to FIG. 1. The wireless system shown in FIG. 1 has a first wireless device 1 to a third wireless device 3. Assume that a communication range of each wireless device in the wireless system according to the embodiment is set in the order of up to tens of cm. In the case of short-range communication in which the communication range of each wireless device is tens of cm as described above, at most several wireless devices are connected to one wireless device. Although the number of wireless devices included in the wireless system is set at 3 in the example of FIG. 1, the number of wireless devices is not limited thereto. For example, the number of wireless devices may be about 2 to 5. In the example of FIG. 1, the first wireless device 1 and the second wireless device 2 perform wireless communication with each other. In addition, the first wireless device 1 and the third wireless device 3 perform wireless communication with each other. The following description will be made on wireless communication between the first wireless device 1 and the second wireless device 2. It is a matter of course that the same description may be applied to wireless communication between the first and third wireless devices 1 and 3 or wireless communication between the second and third wireless devices 2 and 3. In addition, in the wireless system according to the embodiment, a frequency bandwidth which can be used by the wireless system is divided into a plurality (n in the embodiment), and communication is performed using one of first to n-th frequency channels corresponding to the divided frequency bandwidths.

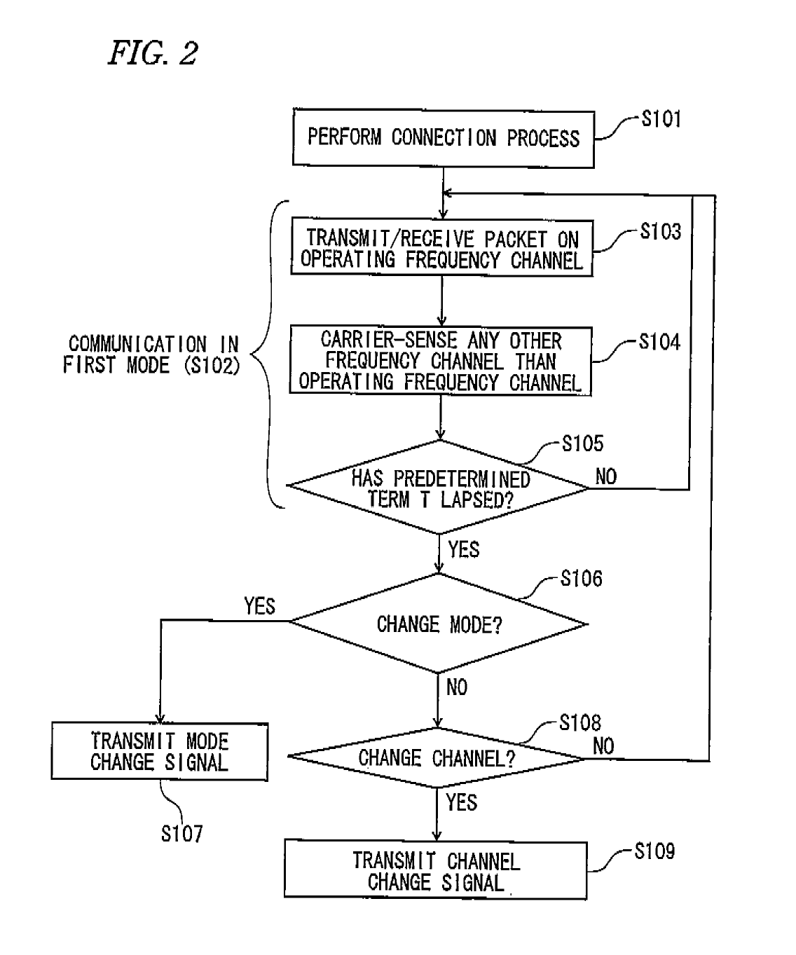

Operation of the wireless system according to the first embodiment will be described with reference to FIGS. 2 to 7.

FIGS. 2 to 4 illustrate operation of the first wireless device 1.

As shown in FIG. 2, first, the first wireless device 1 performs a connection process with the second wireless device 2 to start communication therewith (step S101). The connection process includes exchange of a control single, whereby, for example, the first wireless device 1 transmits a connect request signal (Connect Request) to the second wireless device 2 and the second wireless device 2 receiving the connect request signal transmits a connect accept signal (Connect Accept) to the first wireless device 1. The first wireless device 1 having performed the connection process starts data communication with the second wireless device 2.

After the connection process, the first wireless device 1 performs communication for a predetermined term in a first mode in which a first term for performing communication with the second wireless device 2 on the first frequency channel and a second term for carrier-sensing any other frequency channel than the first frequency channel are repeated (step S102).

Communication in the first mode will be described below in detail. The first wireless device 1 determines a start timing of the first term T1 with the second wireless device 2 at the time of or before the connection process. For example, the first term T1 may be started after a lapse of a predetermined time since a time point that the second wireless device 2 transmits a connect accept signal or a time point that the first wireless device 1 receives the connect accept signal.

In the first term T1, the first wireless device 1 performs communication with the second wireless device 2 in such a manner that the first wireless device 1 transmits a packet and the second wireless device 2 sends back an ACK signal in accordance with a reception status of the packet or the second wireless device 2 transmits a packet and the first wireless device 1 sends back an AGK signal in accordance with a reception status of the packet (step S103). On this occasion, the first and second wireless devices 1 and 2 use one of the first to n-th frequency channels to perform communication with each other. In this embodiment, the frequency channel used for communication is referred to as operating frequency channel. Although the frequency channel used in the connection process is set as an operating frequency channel in the first mode in the embodiment, any other frequency channel than the frequency channel used in the connection process may be set as the operating frequency channel. Hereinafter, description will be made on the assumption that the operating frequency channel in the first mode is regarded as the first frequency channel.

After a lapse of the first term T1, the first wireless device 1 carrier-senses the second to n-th frequency channels other than the operating frequency channel in the second term T2 (step S104). For example, the second term T2 are equally divided into n−1 sub terms and the sub terms are set as second sub terms so that the first wireless device 1 successively carrier-senses one frequency channel in each of the second sub-terms. Alternatively, the first wireless device 1 may carrier-sense the second to n-th frequency channels by use of second terms T2 in such a manner that the first wireless device carrier-senses one frequency channel (e.g. the second frequency channel) in a second term T2, another frequency channel (e.g. the third frequency channel) in a next second term T2 . . . etc. The first wireless device 1 stores carrier sensing results of the second to n-th frequency channels in a storage portion 54 which will be described later.

The first wireless device 1 performs communication in the first term T1 and the second term T2 which are repeated in a predetermined term T (No in step S105).

When the predetermined term T has lapsed (Yes in the step S105), the first wireless device 1 determines whether to change the communication mode from the first mode to a second mode for performing communication at a higher speed than the first mode, change the operating frequency channel for communication to another frequency channel than the first frequency channel, or continue the first mode, in accordance with a communication status in the communication step (step S106).

Specifically, first, the first wireless device 1 determines to change the communication mode from the first mode to the second mode in accordance with the communication status on the first frequency channel. When, for example, SNR or a transmission error rate is smaller than a threshold TH1, the first wireless device 1 regards interference on the first frequency channel as small enough to determine to change the communication mode to the second mode (Yes in the step S106), and transmits a mode change signal to the second wireless device 2 (step S107).

On the other hand, when, for example, the SNR or the transmission error rate is not smaller than the threshold TH1 and interference on the first frequency channel is large (No in the step S106), the first wireless device 1 determines whether to change the operating frequency channel from the first frequency channel to any one of the second to n-th frequency channels or not (step S108).

When, for example, interference on at least one of the second to n-th frequency channels is small, the first wireless device 1 determines to change the frequency channel (Yes in the step S108), and transmits a channel change signal for a request to change the frequency channel to the second wireless device 2 (step S109). Information about the frequency channel with small interference may be included in the channel change signal.

On the other hand, when interference on each of the second to n-th frequency channels is large, the first wireless device 1 determines not to change the frequency channel (No in the step S108) but returns to the step S102 to continue communication in the first mode.

Here, the second mode means a mode for performing communication at a higher speed than the first mode. Specifically, it is assumed that, when communication is performed in the same period of time and in the same communication rate, more data can be transmitted/received in the second mode than in the first mode. For example, the second mode may be a mode in which the second term of the first mode is excluded but the first term is repeated simply. Alternatively, a data modulation system may be changed in the second mode so that more data can be transmitted/received in the second mode than in the first mode. For example, data may be modulated using a QAM modulation system in the second mode while data is modulated using a QPSK modulation system in the first mode.

Further, as another method, each of the first wireless device 1 and the second wireless device 2 may be configured in such a manner that the wireless device checks a reception status by use of an ACK signal in the first term of the first mode while checking a reception status by use of both an ACK signal and an NACK signal in the second mode. In the second mode, the wireless device uses the NACK signal when the reception status is good, and uses the ACK signal when the reception status is poor. An interval for transmission of a data packet when the NACK signal is used can be made shorter than that when the ACK signal is used. In addition, when the ACK signal is used, the data packet can be transmitted surely even if the reception status is poor. Thus, communication in the second mode can be performed at a higher speed than communication in the first mode which uses only the ACK signal. Incidentally, the reception status is determined based on received power or whether a header field of the data packet has been received properly.

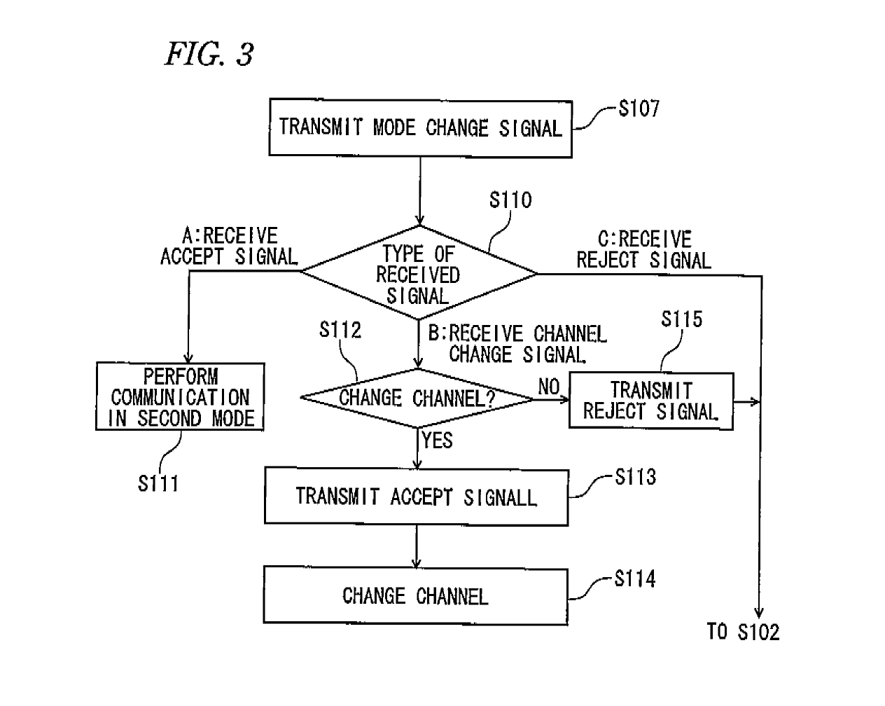

Operation of the first wireless device 1 which has transmitted a mode change signal will be described below with reference to FIG. 3.

The first wireless device 1 having transmitted the mode change signal in the step S107 receives a signal from the second wireless device 2 and performs the following operation in accordance with the type of the received signal. First, when the signal received from the second wireless device 2 is an accept signal (A in step S110), the first wireless device 1 performs communication with the second wireless device 2 in the second mode (step S111).

Then, when the signal received from the second wireless device 2 is a channel change signal (B in the step S110), the first wireless device 1 determines whether to change the operating frequency channel for communication from the first frequency channel to any one of the second to n-th frequency channels or not (step S112).

The first wireless device 1 judges the magnitude of interference on each of the second to n-th frequency channels from the results of carrier sensing performed on the second to n-th frequency channels in the step S104, and determines to change the frequency channel when the interference on at least one of the second to n-th frequency channels is smaller than a threshold TH2 (Yes in the step S112). When the first wireless device 1 has determined to change the frequency channel the first wireless device 1 transmits an accept signal to the second wireless device 2 (step S113), changes the operating frequency channel for communication to another frequency channel than the first frequency channel (step S114), and returns to the step S102 to start communication in the first mode.

On the other hand, when the interference of each of the second to n-th frequency channels is not smaller than the threshold TH2, the first wireless device 1 determines not to change the operating frequency channel (No in the step S112). In this case, the first wireless device 1 transmits a reject signal to the second wireless device 2 (step S115), and returns to the step S102 to start communication in the first mode.

Incidentally, the operating frequency channel may be changed from the first frequency channel to another frequency channel in a predetermined order set between the first and second devices 1 and 2. Alternatively, the second wireless device 2 may transmit a channel change signal including a frequency channel to be changed next. In this case, the first wireless device 1 may determine whether to change the frequency channel based on a result of comparison of the interference on the frequency channel to be changed from the first frequency channel with the threshold TH2 in the step S112.

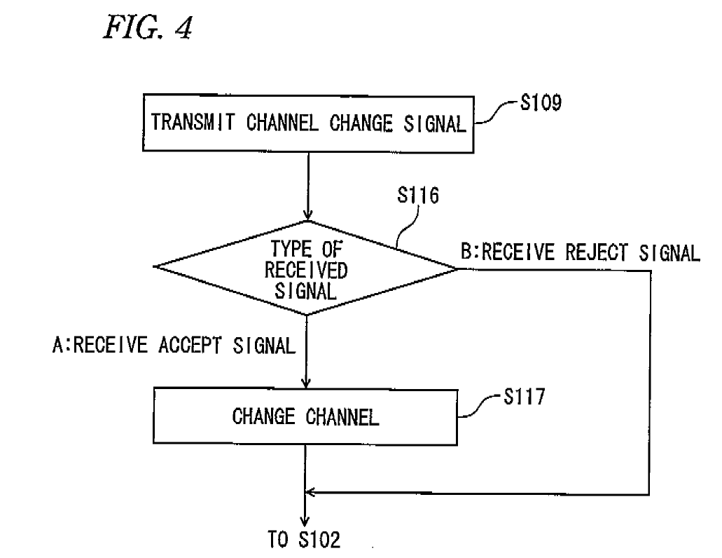

Successively, operation of the first wireless device 1 which has transmitted a channel change signal will be described with reference to FIG. 4.

The first wireless device 1 which has transmitted the channel change signal in the step S109 receives a signal from the second wireless device 2 and performs the following operation in accordance with the type of the received signal. First, when the signal received from the second wireless device 2 is an accept signal (A in step S116), the first wireless device 1 changes the operating frequency channel for communication from the first frequency channel to one of the second to n-th frequency channels (step S117), and returns to the step S102 to start communication in the first mode. Incidentally, the operating frequency channel may be changed from the first frequency channel to another frequency channel in a predetermined order set between the first and second wireless devices 1 and 2. Alternatively, the first wireless device 1 may select at least one frequency channel with small interference, and transmit in a channel change signal including information about the selected frequency channel.

On the other hand, when the signal received from the second wireless device 2 is a reject signal (B in the step S116), the first wireless device 1 does not change the operating frequency channel for communication, but returns to the step S102 to perform communication in the first mode.

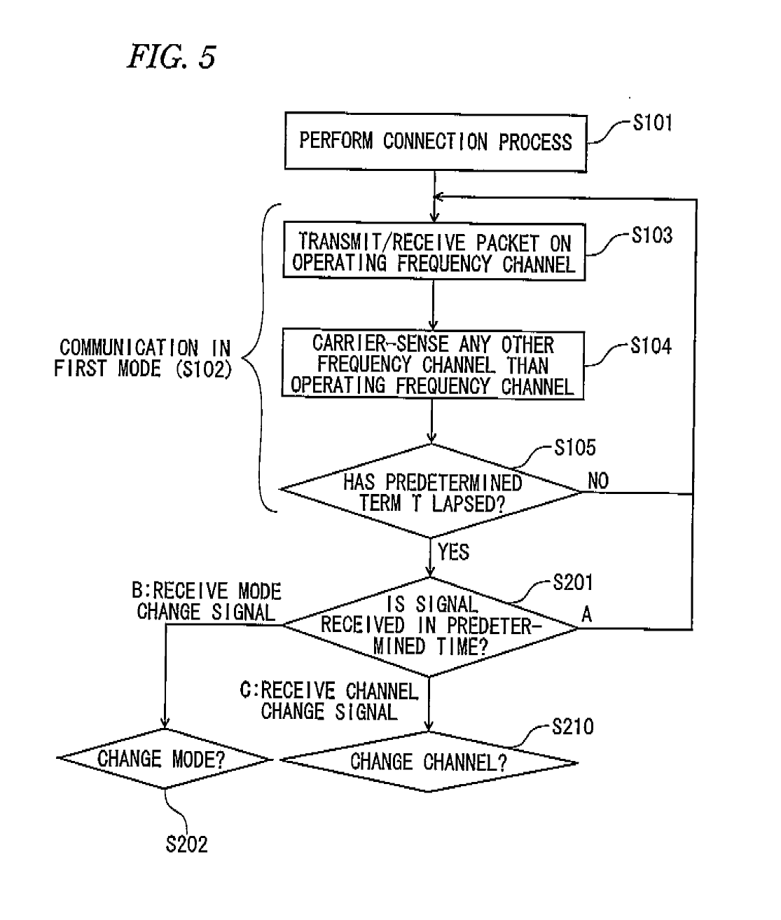

Operation of the second wireless device 2 will be described below with reference to FIGS. 5 to 7.

As shown in FIG. 5, the second wireless device 2 performs a connection process with the first wireless device 1 to start communication therewith (step S101). After the connection process, the second wireless device 2 performs communication for the predetermined term in the first mode in which the first term for performing communication with the first wireless device on the first frequency channel and the second term for carrier-sensing any other frequency channel than the first frequency channel are repeated. Since the connection process and communication in the first mode are the same as those in the step S102, description thereof will be omitted.

When the predetermined term T has lapsed (Yes in the step S105), the second wireless device 2 waits for a signal from the first wireless device 1 in a predetermined time. When the second wireless device 2 does not receive any signal in the predetermined time (A in step S201), the second wireless device 2 returns to the step S102 to perform communication in the first mode.

When the second wireless device 2 has received a mode change signal for a request to change the communication mode to the second mode from the wireless device 1 in the predetermined time (B in the step S201), the second wireless device 2 determines whether to change the communication mode from the first mode to the second mode in accordance with a communication status in the step S102 (step S202).

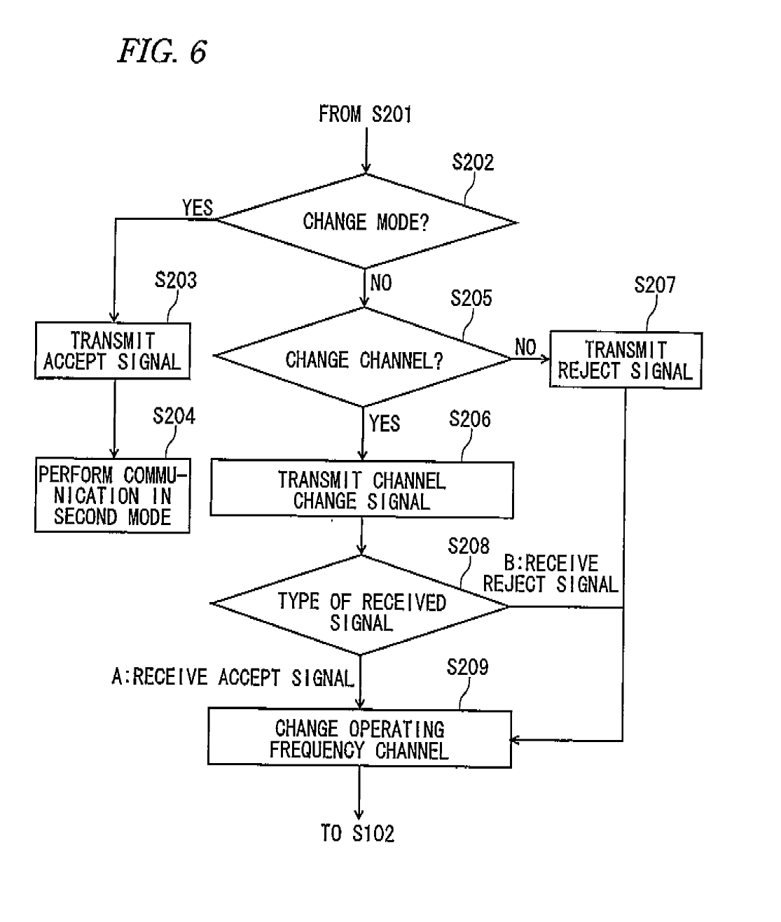

Operation of the second wireless device 2 in and after the step S202 will be described with reference to FIG. 6.

When, for example, the SNR or the transmission error rate is smaller than the threshold TH1, the second wireless device 2 having received a mode change signal regards interference on the first frequency channel as small enough to determine to change the communication mode to the second mode (Yes in the step S202), and transmits an accept signal to the first wireless device 1 (step S203). The second wireless device 2 performs communication in the second mode after transmitting the accept signal (step S204).

On the other hand, when, for example, the SNR or the transmission error rate is not smaller than the threshold TH1 and interference on the first frequency channel is large (No in the step S202), the second wireless device 2 determines to change the operating frequency channel for communication to one of the second to n-th frequency channels from the first frequency channel (step S205).

When, for example, interference on at least one of the second to n-th frequency channels is small, the second wireless device 2 determines to change the frequency channel (Yes in the step S205), and transmits a channel change signal for a request to change the frequency channel, to the first wireless device 1 (Step S206). Information about the frequency channel with small interference may be included in the channel change signal.

The second wireless device 2 having transmitted the channel change signal receives a signal from the first wireless device 1 and performs the following operation in accordance with the type of the received signal. First, when the signal received from the first wireless device 1 is an accept signal (A in step S208), the second wireless device 2 changes the operating frequency channel (step S209), and returns to the step S102 to perform communication with the first wireless device 1 in the first mode.

When the signal received from the first wireless device 1 is a reject signal (B in the step S208), the second wireless device 2 does not change the frequency channel but returns to the step S102 to perform communication with the first wireless device 1 in the first mode.

On the other hand, when interference on each of the second to n-th frequency channels is large, the second wireless device 2 determines not to change the communication mode to the second mode and not to change the frequency channel (No in the step S205), and transmits a reject signal to the first wireless device 1 (step S207). The second wireless device 2 returns to the step S102 to perform communication in the first mode.

Return to FIG. 5. When the second wireless device 2 has received a channel change signal in the step S201 (C in the step S201), the second wireless device 2 determines to change the channel in accordance with a communication status in the step S102 (step S210).

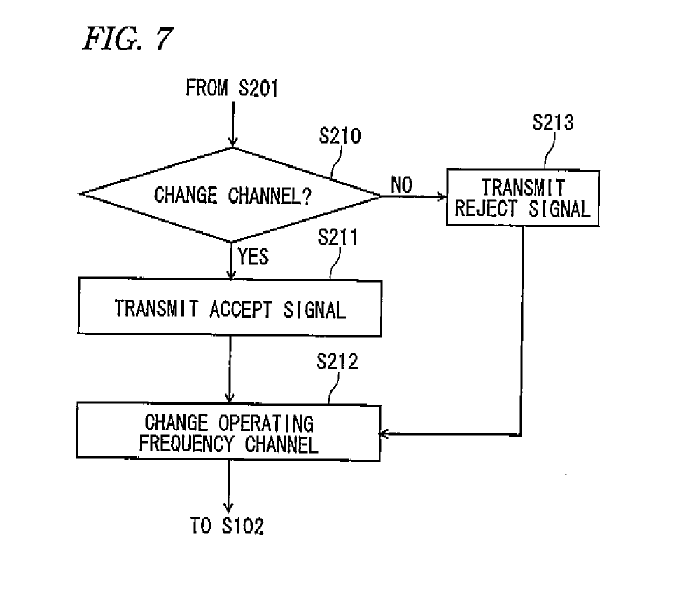

Operation of the second wireless device 2 in and after the step S210 will be described with reference to FIG. 7.

When the signal received from the first wireless device 1 is a channel change signal (C in the step S201), the second wireless device 2 determines whether to change the operating frequency channel for communication to one of the second to n-th frequency channels from the first frequency channel or not (step S210).

The second wireless device 2 judges the magnitude of interference on each of the second to n-th frequency channels from the results of carrier sensing performed on the second to n-th frequency channels in the step S104, and determines to change the operating frequency channel when the interference on at least one of the second to n-th frequency channels is smaller than the threshold TH2 (Yes in the step S210). When the second wireless device 2 determines to change the operating frequency channel, the second wireless device 2 transmits an accept signal to the first wireless device 1 (step S211), changes the operating frequency channel to another frequency channel than the first frequency channel (step S212), and returns to the step S102 to start communication in the first mode.

On the other hand, when the interference on each of the second to n-th frequency channels is not smaller than the threshold TH2, the second wireless device 2 determines not to change the frequency channel (No in the step S210). In this case, the second wireless device 2 transmits a reject signal to the first wireless device 1 (step S213), and returns to the step S102 to perform communication in the first mode.

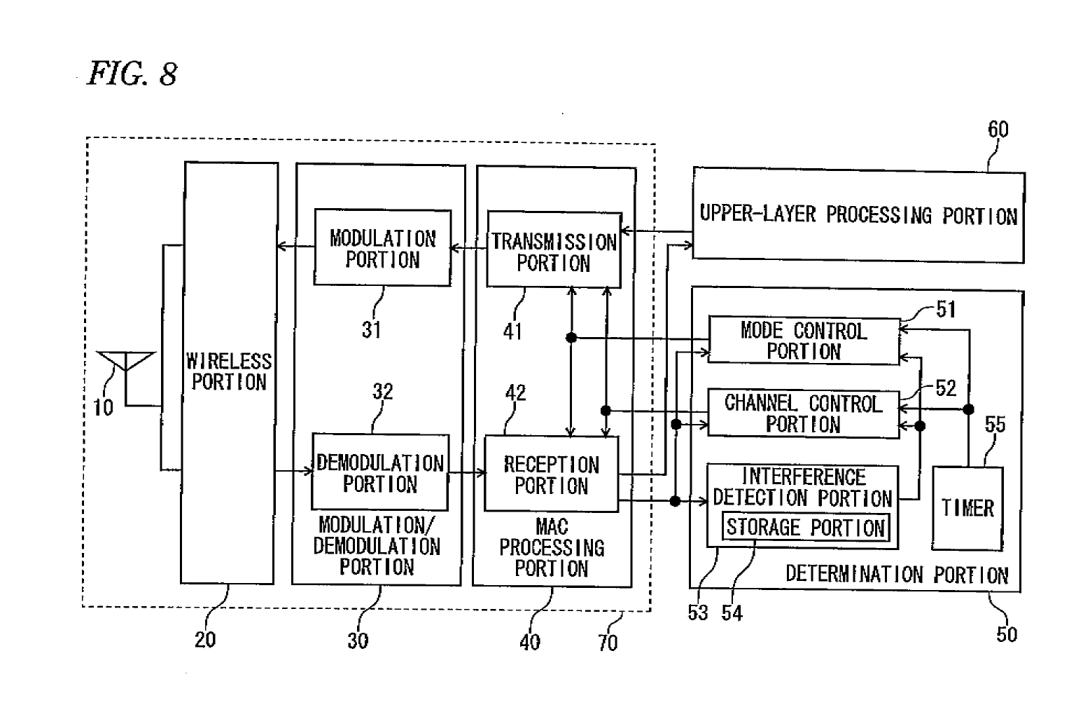

A configuration example of each of the first and second wireless devices 1 and 2 will be described below with reference to FIG. 8. Since the first and second wireless devices 1 and 2 can be implemented by the same constituent members, the configuration of the first wireless device 1 will be described here.

The first wireless device 1 includes a communication portion 70, a determination portion 50 and an upper-layer processing portion 60. The communication portion 70 has an antenna 10, a wireless portion 20, a modulation/demodulation portion 30, and an MAC processing portion. The modulation/demodulation portion 30 has a modulation portion 31 and a demodulation portion 32. The MAC processing portion 40 has a transmission portion 41 and a reception portion 42. The determination portion 50 has a mode control portion 51, a channel control portion 52, an interference detection portion 53, and a timer 55.

The upper-layer processing portion 60 creates packets to be transmitted in the first and second modes and supplies the packets to the transmission portion 41. In addition, the upper-layer processing portion 60 receives reception data from the reception portion 42 and creates data from the reception data.

The determination portion 50 determines whether to change the communication mode from the first mode to the second mode, change the operating frequency channel to another frequency channel than the first frequency channel or continue the first mode in accordance with a communication status in the communication portion 70. On receiving a mode change signal, the determination portion 50 determines to change the mode in accordance with the communication status in the communication portion 70. On receiving a channel change signal, the determination portion 50 determines to change the channel in accordance with the communication status in the communication portion 70.

The respective portions of the determination portion 50 will be described below in detail.

The timer 55 of the determination portion 50 measures a first term T1 and a second term T2 of the first mode and a predetermined term T and sends results of the measurement to the mode control portion 51 and the channel control portion 52.

The mode control portion 51 controls changeover between the first mode and the second mode and changeover between the first term T1 and the second term T2 in the first mode. The mode control portion 51 controls the communication portion 70 to be operated in the first mode or the second mode. When a notification indicating a lapse of the first term T1 is sent from the timer 55 while the communication portion 70 is operated in the first mode, the mode control portion 51 controls the communication portion 70 to carrier-sense any other frequency channel than the operating frequency channel. In addition, when a notification indicating a lapse of the second term T2 is sent from the timer 55 while the communication portion 70 is performing carrier sensing, the mode control portion 51 controls the communication portion 70 to perform packet communication.

When a notification indicating a lapse of the predetermined term T is sent from the timer 55, the mode control portion 51 determines whether to change the mode or not in accordance with the communication status of each of the first to n-th frequency channels stored in the storage portion 54 belonging to the interference detection portion 53. When the mode control portion 51 determines to change the mode from the first mode to the second mode, the mode control portion 51 outputs a mode change signal to the transmission portion 41. When the mode control portion 51 determines not to change the mode from the first mode to the second mode, the mode control portion 51 sends a notification of this determination to the channel control portion 51.

On receiving a mode change signal from the reception portion 42, the mode control portion 51 determines whether to change the mode in accordance with the communication status of each of the first to n-th frequency channels stored in the storage portion 54. When the mode control portion 51 determines to change the mode from the first mode to the second mode, the mode control portion 51 outputs an accept signal to the transmission portion 41. When the mode control portion 51 determines not to change the mode from the first mode to the second mode, the mode control portion 51 sends a notification of this determination to the channel control portion 52.

The channel control portion 52 stores one of the first to n-th frequency channels as the operating frequency channel in advance, and controls the communication portion 70 to be operated on the operating frequency channel. In the case where a notification indicating that mode change is not performed is sent from the mode control portion 51 or a channel change signal is received from the reception portion 42, the channel control portion 52 determines whether to change the operating frequency channel or not in accordance with the communication status of each of the first to n-th frequency channels stored in the storage portion 54. When the channel control portion 52 determines to change the operating frequency channel, the channel control portion 52 outputs a channel change signal or an accept signal to the transmission portion 41. When the channel control portion 52 determines not to change the operating frequency channel, the channel control, portion 52 outputs a reject signal to the transmission portion 41, or sends a notification indicating that communication in the first mode is continued, to the mode control portion 51.

On receiving the communication status using the operating frequency channel, e.g. an error rate or SNR, from the reception portion 42, the interference detection portion 53 stores the communication status in the storage portion 54. On receiving a carrier-sensing result from the reception portion 42 in the second term T2 of the first mode, the interference detection portion 53 stores the carrier-sensing result into the storage portion 54.

The communication portion 70 which has performed the connection process performs communication in the first mode or the second mode higher in speed than the first mode. In the first mode, the first term for performing communication with the second wireless device 2 on the operating frequency channel and the second term for carrier-sensing any other frequency channel than the operating frequency channel are repeated. The communication portion 70 transmits any one of a mode change signal, a channel change signal, an accept signal and a reject signal (hereinafter referred to as determination signal) as a determination result of the determination portion 50 to the second wireless device 2.

The respective portions of the communication portion 70 will be described below in detail. First, description will be made in the case where the communication portion 70 transmits a signal. The transmission portion 41 performs processing such as addition of a header field on data delivered from the upper-layer processing portion 60 or a determination signal delivered from the determination portion 50, to thereby create a data signal. The transmission portion 41 delivers the created data signal to the modulation portion 31.

The modulation portion 31 performs encoding processing, modulation processing and processing such as addition of a physical header etc. on the data signal to thereby create a physical data signal. The wireless portion 20 performs D/A conversion processing, up-conversion processing etc. on the physical data signal to thereby create a transmission signal, and transmits the transmission signal through the antenna 10.

Next, description will be made in the case where the communication portion 70 receives a signal. The reception signal received through the antenna 10 is subjected to processing such as down-conversion, A/D conversion etc. and converted into a physical data signal by the wireless portion 20. The demodulation portion 32 performs demodulation processing and processing such as physical header analysis etc. on the physical data signal to create a data signal. The reception portion 42 performs processing such as header field analysis etc. on the data signal to create data or a determination signal. The reception portion 42 delivers the data to the upper-layer processing portion 60 and delivers the determination signal to the determination portion 50.

In each of the first wireless device 1 and the second wireless device 2 according to the embodiment, whether to change the mode is determined in the mode control portion 51 before whether to change the channel is determined in the channel control portion 52. However, whether to change the mode may be determined after whether to change the channel is determined or at the same time as whether to change the channel is determined. When the first wireless device 1 does not transmit a mode change signal and a channel change signal (No in the step S108 in FIG. 2), the first wireless device 1 does not send a notification to the second wireless device 2 but returns to the step S102 to perform communication in the first mode in the embodiment. Alternatively, the first wireless device 1 may send the second wireless device 2 a notification indicating that the mode is not changed to the second mode but the first mode is continued.

For example, assume that a wireless system as an interference source with respect to the wireless system according to the embodiment transmits a report control signal called Beacon. In this case, the length of the predetermined term T in which the first mode is continued is set to be longer than an interval at which the wireless system as the interference source transmits Beacon.

Even during communication in the first mode, the first wireless device 1 may determine whether to change the mode and whether to change the channel without waiting for a lapse of the predetermined term T if interference is too large to perform communication on the first frequency channel. In addition, even during communication in the second mode, each of the first wireless device 1 and the second wireless device 2 may determine whether to change the mode and whether to change the channel whenever the predetermined term has lapsed or if interference is too large to perform communication on the first frequency channel.

Although the first wireless device 1 having transmitted a connect request signal in the connection process determines whether to change the mode and whether to change the channel after a lapse of the predetermined term T in the embodiment, the second wireless device 2 having received the connect request signal may perform the determination instead.

Although it is exemplified that communication is performed in the first mode when the frequency channel has been changed, communication may be performed not in the first mode but in the second mode when interference on the changed operating frequency channel is small.

As described above, according to the wireless system according to the embodiment, communication is performed in the first mode before carrier sensing is performed after the connection process. Accordingly, a time between the connection process and start of data transmission can be shortened. In addition, since whether to change the mode to the second mode or whether to change the operating frequency channel is determined after a lapse of the predetermined term T, the throughput of the wireless system can be improved.

### Second Embodiment

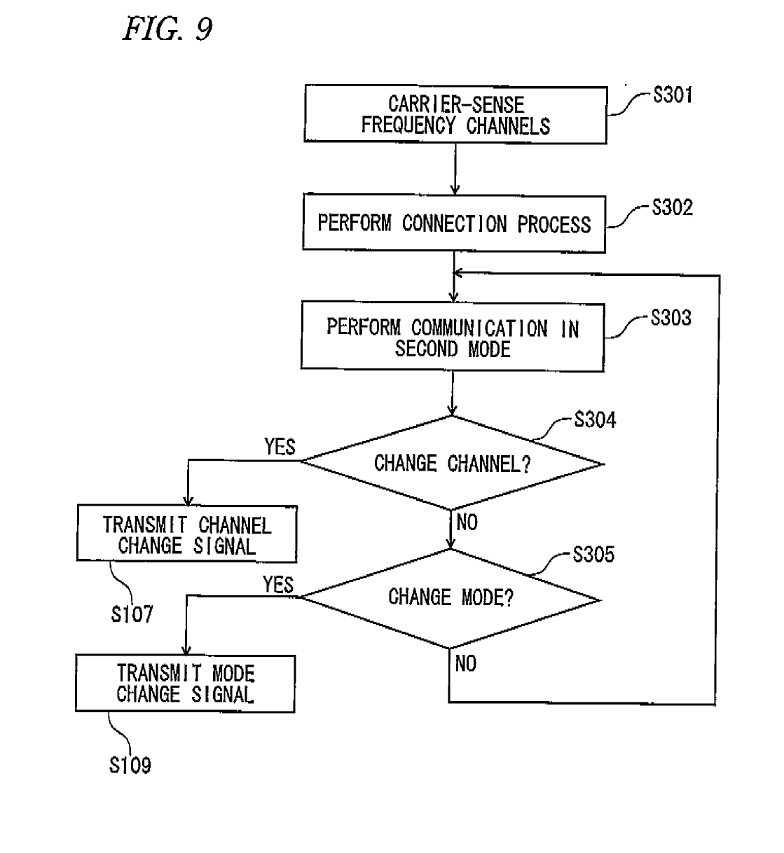

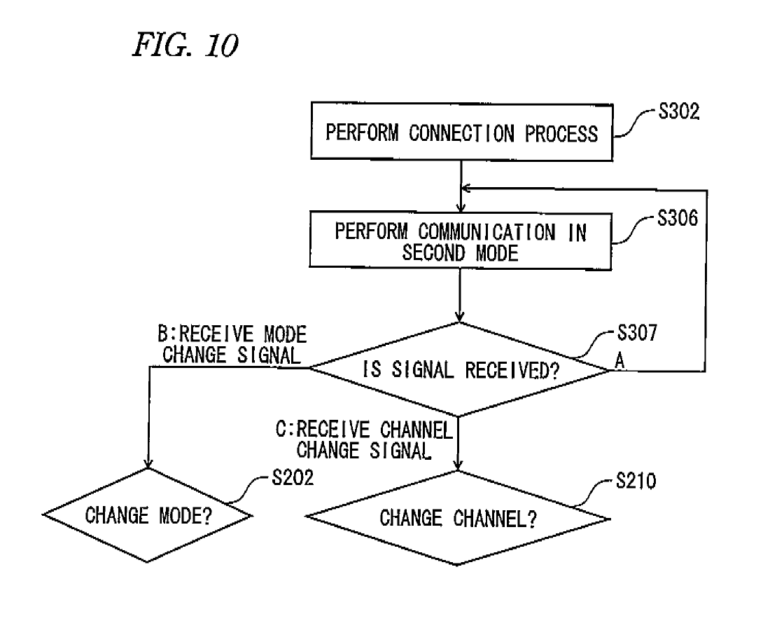

A wireless system according to a second embodiment will be described below with reference to FIGS. 9 and 10. The wireless system in the embodiment is different from that in the first embodiment in the point that the first wireless device 1 according to the embodiment carrier-senses the first to n-th frequency channels before starting communication with the second wireless device 2.

FIG. 9 illustrates an operation flow of the first wireless device 1. The interference detection portion 53 of the first wireless device 1 carrier-senses the first to n-th frequency channels periodically based on a signal received by the communication portion 70 in advance, and stores carrier-sensing results into the storage portion 54 of the interference detection portion 53 in advance (step S301).

Next, the first wireless device 1 performs a connection process with the second wireless device 2 (step S302). The connection process includes exchange of a control signal, whereby, for example, the first wireless device 1 transmits a connect request signal (Connect Request) to the second wireless device 2 and the second wireless device 2 receiving the connect request signal transmits a connect accept signal (Connect Accept) to the first wireless device 1. On this occasion, the channel control portion 52 of the first wireless device 1 according to the embodiment selects at least one frequency channel with small interference from the carrier sensing results stored in the storage portion 54 of the interference detection portion 53, and sends a notification of information of the selected frequency channel (hereinafter referred to as selected frequency channel) to the transmission portion 41 and the mode control portion 51. The transmission portion 41 may transmit the connect request signal including the information of the selected frequency channel. The first wireless device 1 having performed the connection process starts communication with the second wireless device 2.

After the connection process, the mode control portion 51 of the first wireless device 1 controls the communication portion 70 to perform communication with the second wireless device 2 in the second mode on the selected frequency channel (step S303). In the meanwhile, the interference detection portion 53 of the first wireless device 1 detects a communication status of the selected frequency channel, for example, in a regular interval, and sends a detection result to the mode control portion 51 and the channel control portion 52. The mode control portion 51 and the channel control portion 52 receiving the detection result determine whether to change the channel or whether to change the mode when the communication status is deteriorated, for example, with an error rate not higher than a threshold TH3. Incidentally, the interference detection portion 53 may determine whether the communication status on the selected frequency channel is deteriorated or not, and send the determination result to the mode control portion 51 and the channel control portion 52.

When the communication status is deteriorated, the channel control portion 52 of the first wireless device 1 selects whether to change the operating frequency channel to another frequency channel than the selected frequency channel (step S304). On this occasion, the first wireless device 1 determines whether to change the frequency channel or not based on the carrier sensing result in the step S301. When interference received in at least one of the other frequency channels than the selected frequency channel is small, the first wireless device 1 determines to change the operating frequency channel. Since the process after determination is made to change the operating frequency channel is the same as the process shown in FIG. 4, description about the process will be omitted here.

When determination is made not to change the frequency channel, the first wireless device 1 determines whether to change the communication mode from the second mode to the first mode or not (step S305). When the communication status of the selected frequency channel is poor (e.g. the error rate is not lower than a threshold TH1), the mode control portion 51 of the first wireless device 1 determines to change the communication mode to the first mode. Since the process after determination is made to change the mode is the same as the process shown in FIG. 3, description about the process will be omitted here.

Operation of the second wireless device 2 will be described below with reference to FIG. 10.

The communication portion 70 of the second wireless device first performs a connection process (step S301). The communication portion 70 of the second wireless device 2 sends the information of the selected frequency channel included in the received connect request signal to the mode control portion 51 and the channel control portion 52.

The mode control portion 51 receiving the information of the selected frequency channel controls the communication portion 70 to perform communication in the second mode while the channel control portion 52 receiving the information of the selected frequency channel controls the communication portion 70 to perform communication on the selected frequency channel (step S306).

The communication portion 70 of the second wireless device 2 determines whether a determination signal is received or not during communication in the second mode (step S307). When the determination signal is not received (A in the step S307), the communication portion 70 of the second wireless device 2 returns to the step S305 to continue the communication in the second mode. Since the processing flow in the case where the mode change signal is received (B in the step S307) is the same as that of FIG. 6, description thereof will be omitted. Since the processing flow in the case where the channel change signal is received (C in the step S307) is the same as that of FIG. 7, description thereof will be omitted.

Since the configuration of each of the first and second wireless devices 1 and 2 is the same as that in FIG. 8, description thereof will be omitted.

Although it is exemplified that the first wireless device 1 performs carrier sensing prior to the connection process, the second wireless device 2 may perform carrier sensing before the connection process instead. In this case, the second wireless device 2 may transmit the connect accept signal including the information of the selected frequency channel.

Although it is exemplified that the first wireless device 1 determines whether to change the channel and whether to change the mode when the communication status is deteriorated during communication in the second mode, the second wireless device 2 may make the determination instead. As to the determination sequence, whether to change the mode may be determined earlier than whether to change the channel or simultaneously with whether to change the channel. In addition, when the communication status is deteriorated during communication in the second mode, the communication mode may be changed to the first mode without any determination as to whether to change the channel and whether to change the mode. Determination made as to whether to change the channel and whether to change the mode during communication in the second mode may be made every predetermined time regardless of whether the communication status is deteriorated or not.

As described above, in the wireless system according to the embodiment, the frequency channel to be used for communication is offered during the connection process based on a carrier sensing result. In this manner, communication can be started in the second mode after the connection process while time between the connection process and start of data transmission can be shortened. In addition, throughput of the system can be improved.

### (Modification)

Next, a modification of the wireless system according to the second embodiment will be described. In the second embodiment, the first wireless device 1 performs carrier sensing before the connection process. However, accuracy of the carrier sensing result may be not satisfactory for some reason such as a too short time of carrier sensing or a too low level of received power. In the modification, the communication mode after the connection process is changed in accordance with the carrier sensing time or the received power level.

When the carrier sensing time is shorter than a threshold TH4 or the received power level is lower than a threshold TH5, the first wireless device 1 transmits the second wireless device 2 a connect request signal added with information about the carrier sensing time or the received power level.

In this case, the first wireless device 1 or the second wireless device 2 performs communication not in the second mode but in the first mode, for example, in the step S302. Alternatively, even when the first wireless device 1 or the second wireless device 2 performs communication in the second mode, the first wireless device 1 or the second wireless device 2 performs communication while reducing the threshold TH1 or TH3 used for determination as to whether to change the channel or whether to change the mode (hereinafter referred to as third mode). When both an ACK signal and an NACK signal are used in communication in the second mode, for example, only the ACK signal may be used to check a reception status (referred to as fourth mode).

Incidentally, when there is interference in the selected frequency channel in addition to the carrier sensing time and the received power level, a message indicating the presence of interference may be included in the connect request signal.

When carrier sensing of the first to n-th frequency channels is performed thus before the connection process, communication in another mode than the second mode from the first to fourth modes may be selected after the connection process in accordance with the carrier sensing status (the carrier sensing time, the received power level, and the presence/absence of interference). When the first mode is selected, information of the selected frequency channel may be excluded from the connect request signal.

The first wireless device 1 may add not the information of carrier sensing but information of the communication mode to be performed after the connection process to the connect request signal. In addition, the communication mode is not limited to the first to fourth modes. When, for example, determination as to whether to change the channel or whether to change the mode is performed during communication in the second mode in a regular interval, the regular interval may be shortened.

### Third Embodiment

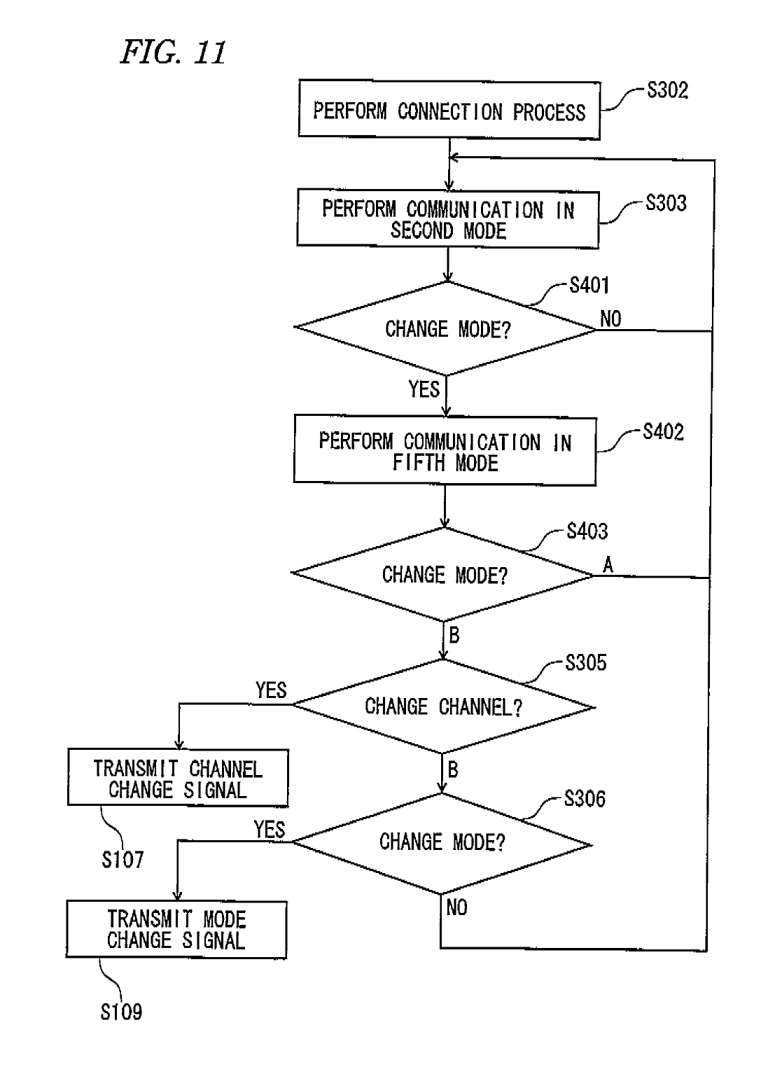

A wireless system according to a third embodiment will be described below with reference to FIG. 11. The embodiment is different from the second embodiment in the point that when the communication status is deteriorated during communication in the second mode, the first wireless device 1 determines whether to change the communication mode to a fifth mode before determining whether to change the communication mode to the first mode or to change the channel.

Since operation up to the step S303 in which communication is performed in the second mode is the same as that in FIG. 9, description thereof is omitted.

During communication in the second mode, the mode control portion 51 of the first wireless device 1 determines whether to change the communication mode from the second mode to the fifth mode or not when the communication status on the selected frequency channel is deteriorated (step S401). When, for example, the error rate is smaller than the threshold TH3, the mode control portion 51 of the first wireless device 1 determines not to change the mode (No in the step S401) but returns to the step S303 to continue communication in the second mode. On the other hand, when, for example, the error rate is not smaller than the threshold TH3, the mode control portion 51 of the first wireless device 1 determines to change the communication mode to the fifth mode (Yes in the step S401).

In this case, the mode control portion 51 of the first wireless device 1 controls the communication portion 70 to send a notification indicating change of the mode to the fifth mode to the second wireless device 2. After the notification, the first wireless device 1 performs communication in the fifth mode (step S402). Incidentally, the fifth mode is a communication mode which is higher in speed than the first mode but lower in speed than the second mode. When, for example, both an ACK signal and an HACK signal are used in communication in the second mode, the fifth mode is set as a communication mode in which only the ACK signal is used to check the reception status or the ACK signal is inserted more frequently than in the second mode. Alternatively, the fifth mode may be set as a communication mode in which an interval between data reception and transmission of the ACK signal is longer than the second mode.

The mode control portion 51 of the first wireless device determines whether to change the mode or not when a predetermined term lapses during communication in the fifth mode (step S403). When the communication status is improved, for example, when the error rate is smaller than the threshold TH3, the mode control portion 51 of the first wireless device 1 determines to change the mode to the second mode (A of the step S403) and returns to the step S303 so as to perform communication in the second mode.

On the other hand, when the communication status is not improved even after the predetermined term has lapsed, for example, when the error rate is not smaller than the threshold TH3 (B of the step S403), the mode control portion 51 of the first wireless device 1 determines whether to select an operating frequency channel or not (step S305). Since the processing flow after the step S305 is the same as that in FIG. 9, description thereof is omitted.

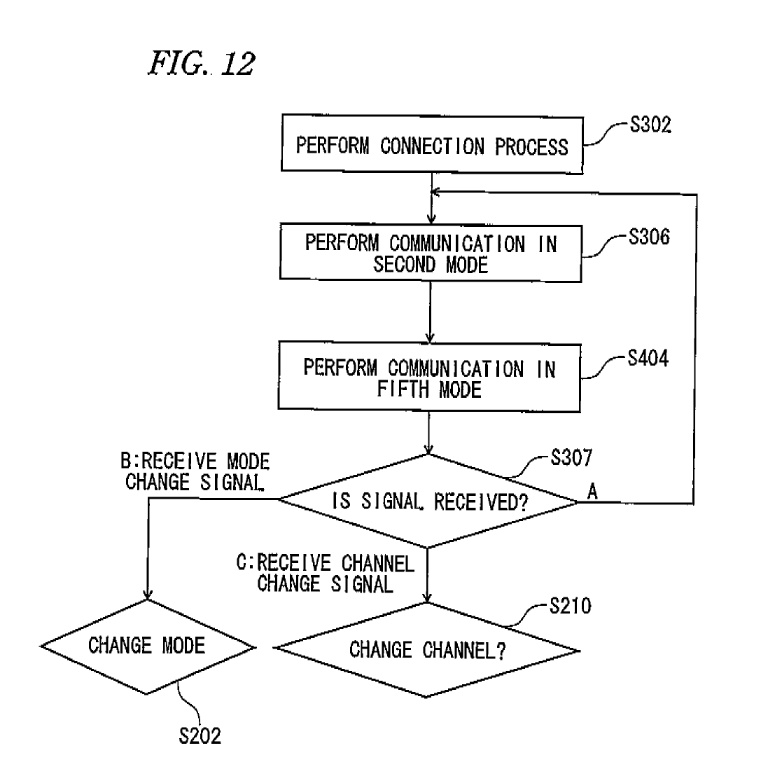

Operation of the second wireless device 2 will be described below with reference to FIG. 12.

When the notification indicating change of the mode to the fifth mode is received from the first wireless device 1 during communication in the second mode (the step S306), the mode control portion 51 of the second wireless device 2 changes the mode to the fifth mode to perform communication (step S404). When a determination signal is received during communication in the fifth mode, the second wireless device 2 performs processing in accordance with the type of the determination signal. Since the processing corresponding to the type of the determination signal is the same as the processing shown in FIG. 10, description thereof will be omitted.

Since the configuration of each of the first and second wireless devices 1 and 2 is the same as that in FIG. 8, description thereof will be omitted.

As described above, in the wireless system according to the embodiment, when the communication status is deteriorated during communication in the second mode, the mode is changed from the second mode to the fifth mode which is higher in speed than the first mode but lower in speed than the second mode before determination is made as to whether to change the mode to the first mode or whether to change the channel. In this manner, communication can be maintained while lowering of the throughput of the wireless system is suppressed.

The embodiment has been described in an example in which the mode is changed to the fifth mode during communication in the second mode after the connection process. Likewise in the case where the mode is changed from the first mode to the second mode in the wireless system according to the first embodiment, whether to change the mode to the first mode or whether to change the channel may be determined after the mode is changed to the fifth mode. In addition, the first wireless device 1 determines whether to change the mode in the embodiment. However, the second wireless device 2 may make the determination instead.

### Fourth Embodiment

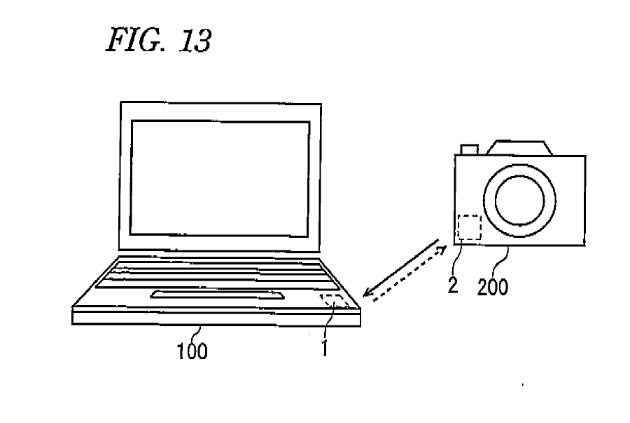

An application example of the wireless system according to the embodiment will be described below with reference to FIG. 13. As shown in FIG. 13, the embodiment shows an application example in which the first and second wireless devices 1 and 2 shown in FIGS. 2 to 8 are mounted on first and second portable terminals 100 and 200.

Each of the first and second portable terminals 100 and 200 is an apparatus which performs short-range communication, such as a notebook PC, a cellular phone, a PDF or a camera. The case where the first portable terminal 100 as a notebook PC and the second portable terminal 200 as a camera communicate with each other is shown in FIG. 13 by way of example. The first portable terminal 100 according to the embodiment includes the first wireless device 1 shown in the first embodiment, and the second portable terminal 200 includes the second wireless device 2 shown in the first embodiment. In the first portable terminal 100 in which the first wireless device 1 is stared up, for example, by a user, periodical transmission of a connect request signal from the first wireless device 1 is triggered by the start-up of the first wireless device 1. When the second wireless device 2 of the second portable terminal 200 approaches the communication range of the first wireless device 1, the second wireless device 2 receives a connect request signal. When the second wireless device 2 transmits a connect accept signal in response to the connect request signal, communication up to the first mode is started between the first and second portable terminals 100 and 200.

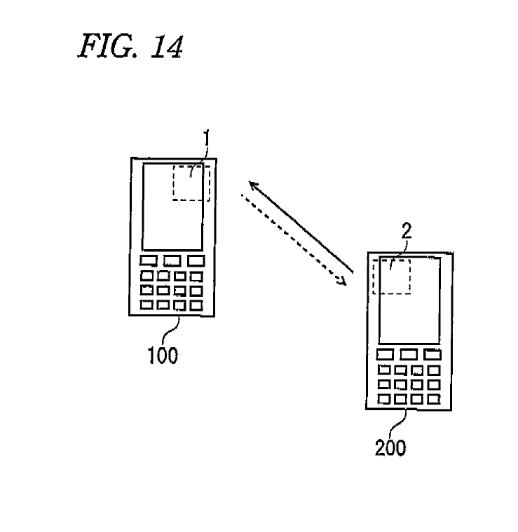

FIG. 14 illustrates another example of the first and second portable terminals 100 and 200. FIG. 14 shows an example in which communication is performed between the first and second portable terminals 100 and 200 serving as cellular phones.

According to the embodiment, as has been described above, the first and second wireless devices 1 and 2 shown in FIGS. 2 to 8 are mounted on portable terminals so that the time between the connection process and the start of data transmission can be shortened in the communication between the portable terminals.

Although it is exemplified that the wireless system according to the first embodiment is mounted on the first and second terminals 100 and 200, the wireless system according to the second or third embodiment may be mounted instead.

Although it is exemplified that the first wireless device 1 is mounted on the first portable terminal 100 and the second wireless device 2 is mounted on the second portable terminal 200, the second wireless device 2 may be mounted on the first portable terminal 100 while the first wireless device 1 is mounted on the second portable terminal 200.

### Fifth Embodiment

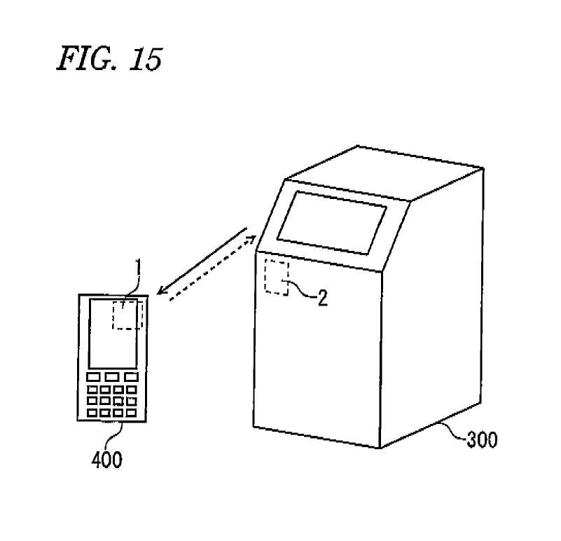

Next, an application example of the wireless system according to the embodiment will be described with reference to FIG. 15. As shown in FIG. 15, the embodiment shows an application example in which the first wireless device 1 shown in the second embodiment is mounted on a communication terminal 300 and the second wireless device 2 shown in the same is mounted on a portable terminal 400.

Differently from the portable terminal 400, the communication terminal 300 is a terminal which is installed indoors or outdoors but rarely moved. The communication terminal 300 is, for example, an information KIOSK terminal or a desktop PC. The portable terminal 400 is a terminal which can be often carried in use. The portable terminal 400 is, for example, a notebook PC, a cellular phone, a PDF or a camera.

FIG. 15 shows an example in which communication is made between the communication terminal 300 as an information KIOSK terminal and the portable terminal 400 as a cellular phone. The communication terminal 300 according to the embodiment includes the first wireless device 1 shown in the second embodiment. When the portable terminal 900 is out of the communication range, the communication terminal 300 performs carrier sensing on the first to n-th frequency channels periodically. The portable terminal 400 includes the second wireless device 2 shown in the second embodiment. The communication terminal 300 repeats the aforementioned carrier sensing on the first to n-th frequency channels and transmission of a connect request signal periodically. When the second wireless device 2 of the portable terminal 400 approaches the communication range of the first wireless device 1, the second wireless device 2 receives the connect request signal. When the second wireless device 2 transmits a connect accept signal in response to the connect request signal, communication in the first mode or the second mode is started between the communication terminal 300 and the portable terminal 400.

According to the embodiment, as has been described above, the first and second wireless devices 1 and 2 according to the second embodiment are mounted on a communication terminal and a portable terminal so that the time between the connection process and the start of data transmission can be shortened in the communication between the communication terminal and the portable terminal.

Although it is exemplified that the communication terminal 300 transmits a connect request signal, the communication terminal 300 may perform carrier sensing on the first to n-th frequency channels before the connection process while the portable terminal 400 transmits a connect request signal. In this case, the communication terminal 300 does not have to repeat the transmission of the connect request signal and the carrier sensing. Thus, the term of the carrier sensing on the first to n-th frequency channels can be elongated.

Although it is exemplified that the wireless system according to the second embodiment is mounted on the communication terminal 300 and the portable terminal 400, the wireless system according to the first or third embodiment may be mounted instead.

Although some embodiments have been described, these embodiments are presented by way of example but have no intention of limiting the scope of the invention. These novel embodiments may be carried out in other various modes and can be omitted, replaced or changed variously without departing from the scope of the invention. Not only the embodiments and their modifications but also their equivalents fall within the scope of Claims.

1. A wireless communication method, comprising:
a start step of performing a connection process with a second wireless device;
after the start step, a communication step of performing communication for a predetermined term in a first mode in which a first term and a second term are repeated, the first term for performing communication with the second wireless device on a first frequency channel, the second term for carrier-sensing any other frequency channel than the first frequency channel;
a determination step of determining, in accordance with a communication status in the communication step, whether to
change a communication mode from the first mode to a second mode in which communication at a higher speed than the first mode is performed,
change an operating frequency channel for communication to another frequency channel than the first frequency channel, or
continue the first mode; and
a transmission step of transmitting a mode change signal when the determination is made to change the communication mode to the second mode, and transmitting a channel change signal when the determination is made to change the operating frequency channel to the other frequency channel than the first frequency channel.

2. The method of claim 1, further comprising:
after the start step, a second communication step of performing communication in the second mode on a notified operating frequency channel which is notified during the start step from the second wireless device.

3. The method of claim 1, further comprising:
a second transmission step of transmitting a second mode change signal for changing the communication mode to the first mode in accordance with the communication status, when communication is being made in the second mode.

4. The method of claim 1, further comprising:
a third transmission step of transmitting a second channel change signal for changing the operating frequency channel to the other frequency channel than the operating frequency channel for communication in accordance with the communication status, when communication is being made in the second mode.

5. A wireless communication method, comprising:
a start step of performing a connection process with a first wireless device;
after the start step, a communication step of performing communication for a predetermined term in a first mode in which a first term and a second term are repeated, the first term for performing communication with the first wireless device on a first frequency channel, the second term for carrier-sensing any other frequency channel than the first frequency channel;
a first determination step of determining, in accordance with a communication status in the communication step, whether to change a communication mode from the first mode to a second mode in which communication at a higher speed than the first mode is performed upon receiving a mode change signal for changing the communication mode to the second mode from the first wireless device; and
a second determination step of determining, in accordance with the communication status in the communication step, whether to change an operating frequency channel for communication upon receiving a channel change signal for changing the operating frequency channel to another frequency channel than the first frequency channel from the first, wireless device.

6. The method of claim 5, further comprising:
after the start step, a second communication step of performing communication in the second mode on a notified operating frequency channel which is notified during the start step from the first wireless device.

7. The method of claim 5, further comprising:
a second transmission step of transmitting a second mode change signal for changing the communication mode to the first mode in accordance with the communication status, when communication is being made in the second mode.

8. The method of claim 5, further comprising:
a third transmission step of transmitting a second channel change signal for changing the frequency channel to any other frequency channel than the operating frequency channel for communication in accordance with the communication status, when the communication is being made in the second mode.

9. The method of claim 1,
wherein, in the second mode, communication using NACK and ACK signals is performed, and
wherein the method further comprises:
a third communication step for performing communication in a third mode using the ACK signal more frequently than the second mode, in accordance with the communication status of the communication performed in the second mode; and
a fourth transmission step for transmitting the second mode change signal or the channel change signal in accordance with the communication status, when communication is being made in the third communication step.

10. The method of claim 1,
wherein, in the second mode, communication using at least an ACK signal is performed, and
wherein the method further comprises:
a fourth communication step for performing communication in a fourth mode in which a transmission interval between completion of reception of data and transmission of the ACK signal is longer than in the second mode, in accordance with the communication status of the communication performed in the second mode; and
a fifth transmission step for transmitting the second mode change signal or the channel change signal in accordance with the communication status, when communication is being made in the fourth communication step.

11. The method of claim 9,
wherein the start step includes carrier sensing on frequency channels, and
wherein a notification indicating that communication will be made on the communication frequency channel and in one of the first to third modes is sent during the connection process based on a result of the carrier sensing.

12. A wireless device, comprising:
a communication portion configured to perform a connection process with a second wireless device to thereby perform communication for a predetermined term in a first mode in which a first term and a second term are repeated, the first term for performing communication with the second wireless device on a first frequency channel, the second term for carrier-sensing any other frequency channel than the first frequency channel; and
a determination portion configured to determine, in accordance with a communication status in the communication portion, whether to
change a communication mode from the first mode to a second mode in which communication at a higher speed than the first mode is performed,
change an operating frequency channel for communication to another frequency channel than the first frequency channel, or
continue the first mode,
wherein the communication portion transmits a mode change signal when the determination is made to change the communication mode to the second mode, and transmits a channel change signal when the determination is made to change the operating frequency channel to the other frequency channel than the first frequency channel.

13. A wireless device, comprising:
a communication portion configured to perform a connection process with a first wireless device to thereby perform communication for a predetermined term in a first mode in which a first term and a second term are repeated, the first term for performing communication with the first wireless device on a first frequency channel, the second term for carrier-sensing any other frequency channel than the first frequency channel; and
a determination portion configured to determine, in accordance with a communication status in the communication portion, whether to change a communication mode from the first mode to a second mode in which communication at a higher speed than the first mode is performed upon receiving mode change signal for changing the communication mode to the second mode from the first wireless device, and to determine, in accordance with the communication status in the communication portion, whether to change an operating frequency channel for communication upon receiving a channel change signal for changing the operating frequency channel to another frequency channel than the first frequency channel from the first wireless device,
wherein the communication portion sends a notification of a determination result in the determination portion to the first wireless device.
